(19) United States
(12) Patent Application Publication
(10) Pub. No.: US 2026/0106963 A1
(43) Pub. Date: Apr. 16, 2026

(54) METHOD FOR CALIBRATING LIQUID CRYSTAL PRISM OF DISPLAY DEVICE AND DISPLAY DEVICE

(71) Applicant: Shanghai Tianma Microelectronics Co., Ltd., Shanghai (CN)

(72) Inventors: Qijun Yao, Shanghai (CN); Yaodong Wu, Shanghai (CN)

(73) Assignee: Shanghai Tianma Microelectronics Co., Ltd., Shanghai (CN)

(21) Appl. No.: 19/376,340

(22) Filed: Oct. 31, 2025

(30) Foreign Application Priority Data
Jul. 29, 2025 (CN) 202511054537.0

(51) Int. Cl. H04N 13/327; H04N 13/32; H04N 13/346; H04N 13/398

(52) U.S. Cl. CPC H04N 13/327; H04N 13/32; H04N 13/346; H04N 13/398

(57) ABSTRACT

Provided are a method for calibrating a liquid crystal prism and a display device. The method includes: applying a first driving voltage to a liquid crystal prism based on a first mapping relationship, controlling a first and second visual areas to display a first image of solid color, a third and fourth visual areas to display a second image of nonsolid color and including a main pattern; acquiring a second driving voltage based on visibility of the main pattern at the first view point; and applying a second driving voltage to the liquid crystal prism, controlling one of the third and fourth visual areas to display the second image and the other not to display in a same time period, and acquiring a second mapping relationship based on the visibility of the main pattern at the first view point.

### CROSS-REFERENCE TO RELATED APPLICATIONS

The present application claims priority to Chinese Patent Application No. 202511054537.0, filed on July 29, 2025, the content of which is incorporated herein by reference in its entirety.

### TECHNICAL FIELD

The present disclosure relates to the field of display technologies, and more specifically, a method for calibrating a liquid crystal prism of a display device and a display device.

### BACKGROUND

Three-Dimensional (3D) display is a technology capable of presenting images with a three-dimensional spatial perception. In the 3D display, a display device has a specific visual area range; the visual area range includes a plurality of visual areas; and, when an observer watches a screen at a certain view point, a left eye of the observer may view a left-eye image presented in one visual area, while a right eye of the observer may view a right-eye image presented in another visual area, so that the brain fuses the two images with parallax together to generate a stereoscopic vision.

However, there is crosstalk between the light exited from different visual areas, which causes the problem that the 3D image perceived by the observer has ghosting or blurring, and seriously affects the watching experience of the observer and the application effect of the 3D display.

Embodiments of the present disclosure provide a method for calibrating a liquid crystal prism of a display device and a display device, which are used for improving the crosstalk between the light exited from different visual areas.

In a first aspect, embodiments of the present disclosure provide a method for calibrating a liquid crystal prism of a display device.

The display device includes a display panel and a plurality of liquid crystal prisms located on a light-emitting side of the display panel, the display panel includes a plurality of sub-pixels, one of the plurality of liquid crystal prisms overlaps with the plurality of sub-pixels in a direction perpendicular to a plane of the display panel, and the plurality of sub-pixels overlapped by the one liquid crystal prism are respectively configured to present images of different visual areas.

The method for calibrating a liquid crystal prism of the display device includes:

step S1: applying a first driving voltage to the one liquid crystal prism based on a first mapping relationship, controlling a first visual area and a second visual area to display a first image, and controlling a third visual area and a fourth visual area to display a second image, where the first mapping relationship is a corresponding relationship between the plurality of sub-pixels overlapped by the one liquid crystal prism and a plurality of visual areas, the first visual area and the second visual area are respectively configured to present a left-eye image and a right-eye image at a first view point, the first image is a solid-color image, the second image is a nonsolid-color image, and the second image includes a main pattern;

step S2: acquiring a second driving voltage based on visibility of the main pattern at the first view point; and

step S3: applying the second driving voltage to the one liquid crystal prism, controlling one of the third visual area and the fourth visual area to display the second image and the other of the third visual area and the fourth visual area not to display in a same time period, and acquiring a second mapping relationship based on the visibility of the main pattern at the first view point, where the second mapping relationship is a corresponding relationship between the plurality of sub-pixels overlapped by the one liquid crystal prism and the plurality of visual areas.

In a second aspect, based on the same inventive concept, embodiments of the present disclosure further provide a display device, including: a display panel including a plurality of sub-pixels; and a plurality of liquid crystal prisms located on a light-emitting side of the display panel, where one of the plurality of liquid crystal prisms overlaps with the plurality of sub-pixels in a direction perpendicular to a plane of the display panel, and the plurality of sub-pixels overlapped by the one liquid crystal prism are respectively configured to present images of different visual areas. The one liquid crystal prism is calibrated by implement: applying a first driving voltage to the one liquid crystal prism based on a first mapping relationship, controlling a first visual area and a second visual area to display a first image, and controlling a third visual area and a fourth visual area to display a second image, where the first mapping relationship is a corresponding relationship between the plurality of sub-pixels overlapped by the one liquid crystal prism and a plurality of visual areas, the first visual area and the second visual area are respectively configured to present a left-eye image and a right-eye image at a first view point, the first image is a solid-color image, the second image is a nonsolid-color image, and the second image includes a main pattern; acquiring a second driving voltage based on visibility of the main pattern at the first view point; and applying the second driving voltage to the one liquid crystal prism, controlling one of the third visual area and the fourth visual area to display the second image and the other of the third visual area and the fourth visual area not to display in a same time period, and acquiring a second mapping relationship based on the visibility of the main pattern at the first view point, where the second mapping relationship is a corresponding relationship between the plurality of sub-pixels overlapped by the one liquid crystal prism and the plurality of visual areas.

### BRIEF DESCRIPTION OF DRAWINGS

In order to better illustrate the technical solutions in the embodiments of the present disclosure or the related art, the drawings used in the description of the embodiments will be briefly illustrated as follows. It should be understood that the drawings in the following description are merely some of, rather than all of the embodiments of the present disclosure. For those skilled in the art, other drawings can be obtained in accordance with these drawings without any creative efforts.

FIG. 1 is a schematic structural diagram of a display device according to an embodiment of the present disclosure.

FIG. 2 is a schematic diagram of light emission of a sub-pixel according to an embodiment of the present disclosure.

FIG. 3 is another schematic diagram of light emission of a sub-pixel according to an embodiment of the present disclosure.

FIG. 4 is a flowchart of a method for calibrating a liquid crystal prism of a display device according to an embodiment of the present disclosure.

FIG. 5 is a 3D image at a first view point according to an embodiment of the present disclosure.

FIG. 6 is a schematic diagram of region division of a display device according to an embodiment of the present disclosure.

FIG. 7 is another flowchart of a method for calibrating a liquid crystal prism of a display device according to an embodiment of the present disclosure.

FIG. 8 is another flowchart of a method for calibrating a liquid crystal prism of a display device according to an embodiment of the present disclosure.

FIG. 9 is another flowchart of a method for calibrating a liquid crystal prism of a display device according to an embodiment of the present disclosure.

FIG. 10 is another flowchart of a method for calibrating a liquid crystal prism of a display device according to an embodiment of the present disclosure.

### DESCRIPTION OF EMBODIMENTS

In order to better understand technical solutions of the present disclosure, embodiments of the present disclosure are described in detail below in conjunction with the drawings.

It should be understood that the described embodiments are only some rather than all of the embodiments of the present disclosure. All other embodiments obtained by those skilled in the art based on the embodiments of the present disclosure without creative efforts should fall within the protection scope of the present disclosure.

Terms used in the embodiments of the present disclosure are merely for the purpose of describing specific embodiments, and are not intended to limit the present disclosure. Singular forms of “a/an”, “the” and “said” used in the embodiments of the present disclosure and the appended claims are also intended to include plural forms, unless clearly indicating others.

It should be understood that the term “and/or” used herein is merely an association relationship describing an associated object, and indicates that there may be three relationships, for example, A and/or B, and may indicate: only A, both A and B, and only B. In addition, the character “/” herein generally indicates an “or” relationship between the associated objects.

In a structure for implementing 3D display, a display device includes a display panel and a plurality of liquid crystal prisms located on a light-emitting side of the display panel.

The display panel includes sub-pixels, and each liquid crystal prism overlaps with a plurality of sub-pixels in a direction perpendicular to a plane where the display device is located. The liquid crystal prism controls a transmission direction of the light emitted by the overlapped sub-pixels by controlling an arrangement state of the liquid crystals in the liquid crystal prism, so that the light emitted by different sub-pixels passes through the liquid crystal prism and then is transmitted towards different visual areas, and each visual area forms a specific image.

When an observer watches a screen, each view point corresponds to two effective visual areas, one of the two effective visual areas is used as a left visual area to present a left-eye image, and the other is used as a right visual area to present a right-eye image.

The liquid crystal prism may accurately control the transmission direction of the light of the plurality of sub-pixels overlapped with the liquid crystal prism, so that the light of each sub-pixel can be accurately transmitted to the corresponding visual area. Further, at each view point, the left eye and the right eye of the observer can each view images of two effective visual areas, and cannot view images of other non-effective visual areas.

However, in practical applications, due to the influence of factors such as process accuracy, alignment accuracy and environment, the thickness of the liquid crystal prism may fluctuate and deviate from the designed value. Additionally, lateral alignment deviation may occur between the liquid crystal prism and the display panel, which results in the change of the overlapping relationship between the liquid crystal prism and the sub-pixels. Both of the above cases may cause the misalignment between the image source plane and the focal plane of the liquid crystal prism, such that the control accuracy of the liquid crystal prism on the refraction of the emitted light is reduced. Light that should be originally incident into a certain visual area after the action of the liquid crystal prism may be mixed into another visual area, which leads to the visual area crosstalk phenomenon, and the 3D image perceived by the observer has the problem of ghosting or blurring.

In this regard, embodiments of the present disclosure provide a method for calibrating a liquid crystal prism of a display device, which can calibrate a driving voltage of the liquid crystal prism and a corresponding relationship between a plurality of sub-pixels overlapped by the liquid crystal prism and a plurality of visual areas, such that a problem of visual area crosstalk caused by thickness fluctuation of the liquid crystal prism and lateral shift of the liquid crystal prisms can be effectively improved.

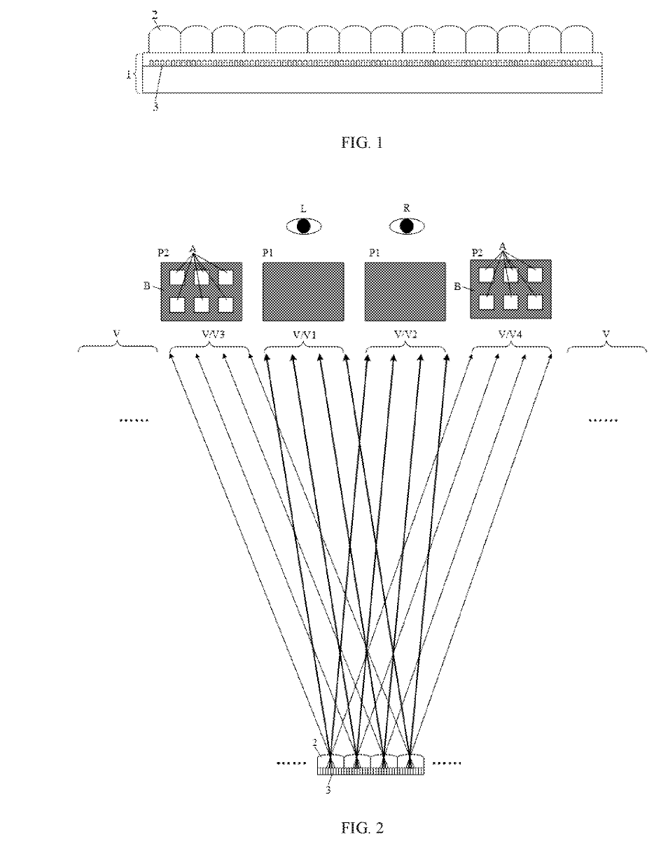

The method for calibrating the liquid crystal prism according to the present disclosure can be applied to the structure shown in FIG. 1, which is a schematic structural diagram of a display device according to an embodiment of the present disclosure. In the exemplary embodiment shown in FIG. 1, the display device includes a display panel 1 and a plurality of liquid crystal prisms 2 located on a light-emitting side of the display panel 1. The display panel 1 includes a plurality of sub-pixels 3. Each liquid crystal prism 2 overlaps a plurality of sub-pixels in a direction perpendicular to a plane where the display panel 1 is located, and the plurality of sub-pixels 3 overlapped by a liquid crystal prism 2 are respectively configured to present images of different visual areas.

In one structure, a liquid crystal prism 2 includes a first electrode, a liquid crystal and a second electrode. The first electrode may be configured to receive a common voltage, the second electrode may be configured to receive the driving voltage, and the liquid crystal may be configured to deflect under the action of an electric field formed by the first electrode and the second electrode, so that the liquid crystal prism 2 controls light.

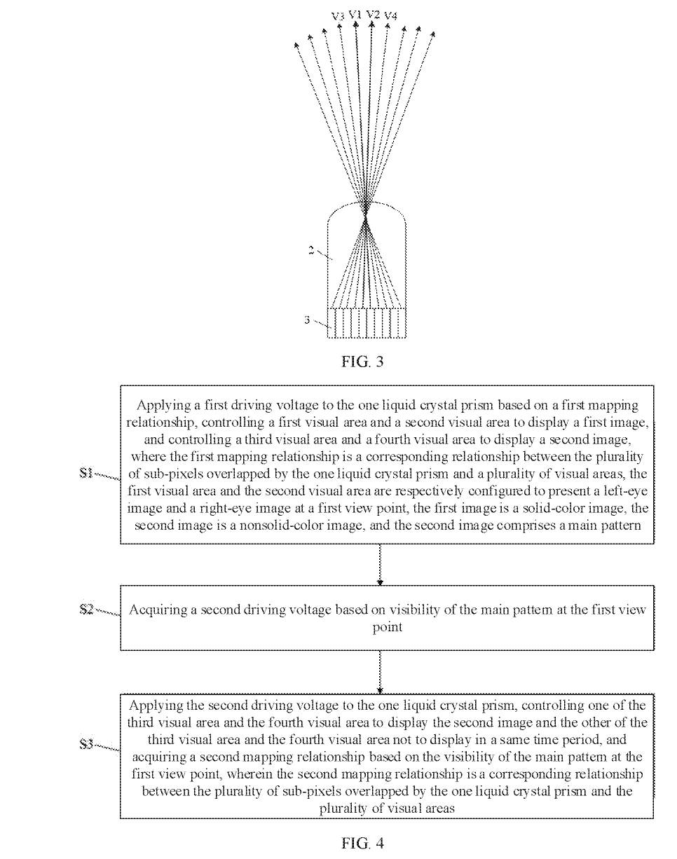

FIG. 2 is a schematic diagram of light emission of a sub-pixel according to an embodiment of the present disclosure, and FIG. 3 is another schematic diagram of light emission of a sub-pixel according to an embodiment of the present disclosure. In the exemplary embodiments illustrated in FIG. 2 and FIG. 3, the plurality of sub-pixels 3 overlapped by a liquid crystal prism 2 may correspond to a plurality of visual areas V. The liquid crystal prism 2 may adjust the transmission direction of the light emitted by the plurality of sub-pixels 3 overlapped by the liquid crystal prism 2. The light emitted by a sub-pixel 3 may be transmitted toward an orientation of the corresponding visual area V after passing through the liquid crystal prism 2, so that different visual areas V form a specific image.

FIG. 4 is a flowchart of a method for calibrating a liquid crystal prism of a display device according to an embodiment of the present disclosure. I In combination with FIG. 1 to FIG. 4, the method for calibrating the liquid crystal prism of the display device includes steps as follows.

Step S1 may include applying a first driving voltage to the liquid crystal prism 2 based on a first mapping relationship, controlling a first visual area V1 and a second visual area V2 to display a first image P1, and controlling a third visual area V3 and a fourth visual area V4 to display a second image P2.

The first mapping relationship may be understood as an initial corresponding relationship between the plurality of sub-pixels 3 overlapped by the liquid crystal prism 2 before calibration and the plurality of viewing areas V. The first driving voltage may be understood as an initial driving voltage provided for the liquid crystal prism 2 before calibration.

The first visual area V1 and the second visual area V2 may be configured to present at a first view point a left-eye image and a right-eye image, respectively. That is, the first visual area V1 and the second visual area V2 may be two effective visual areas at the first view point, and the third visual area V3 and the fourth visual area V4 may be non-effective visual areas at the first view point. At the first view point, the observer can only see the images of the first visual area V1 and the second visual area V2, and cannot see the images of the third visual area V3 and the fourth visual area V4. Referring to FIG. 2, the third visual area V3 and the fourth visual area V4 may be located on two opposite sides of the two effective visual areas of the first visual area V1 and the second visual area V2. For example, the third visual area V3 may be located on the side of the first visual area V1 away from the second visual area V2, and the fourth visual area V4 may be located on the side of the second visual area V2 away from the first visual area V1.

In the exemplary embodiment, the first image P1 is a solid-color image, and the second image P2 is a nonsolid-color image. The second image P2 may include a main pattern A, which is a test pattern for determining a crosstalk condition of the third visual area V3. The fourth visual area V4 and the brightness of the main pattern A may be different from the brightness of the first image P1.

Step S2 may include acquiring a second driving voltage according to a visibility of the main pattern A at the first view point.

The second driving voltage may be a better driving voltage after calibration, and the second driving voltage may be different from the first driving voltage.

Step S3 may include applying the second driving voltage to the liquid crystal prism 2, controlling one of the third visual area V3 and the fourth visual area V4 to display the second image P2 and the other not to display in a same time period, and acquiring a second mapping relationship according to the visibility of the main pattern A at the first view point.

The second mapping relationship may be a corresponding relationship between the plurality of sub-pixels 3 overlapped by the liquid crystal prism 2 and the plurality of visual areas V. The second mapping relationship may be a better corresponding relationship after calibration, and the second mapping relationship may be different from the first mapping relationship.

It should be understood that the adjustment of the corresponding relationship between the sub-pixels 3 and the visual areas V is essentially the adjustment of a data voltage received by the sub-pixels 3. For example, in the first mapping relationship, a certain sub-pixel 3 corresponds to a certain visual area V, when the display is driven under the first mapping relationship, the data voltage corresponding to a display content of the visual area V is provided to the sub-pixel 3, and the sub-pixel 3 is configured to present an image to be displayed in the visual area V. After the mapping relationship is adjusted, the sub-pixel 3 may correspond to another visual area V. When the display is driven under the adjusted mapping relationship, the data voltage corresponding to a display content of the another visual area V may be provided to the sub-pixel 3, and the sub-pixel 3 may be configured to present an image to be displayed in the another visual area V.

In combination with the above analysis, at the first view point, the main patterns displayed in the third visual area V3 and the fourth visual area V4 may not be seen. However, due to factors such as process accuracy, alignment accuracy, and environment, thickness fluctuation of the liquid crystal prism and lateral shift of the liquid crystal prism may cause misalignment between the image source plane and the focal plane of the liquid crystal prism, thereby causing crosstalk between the third visual area V3 and the fourth visual area V4.

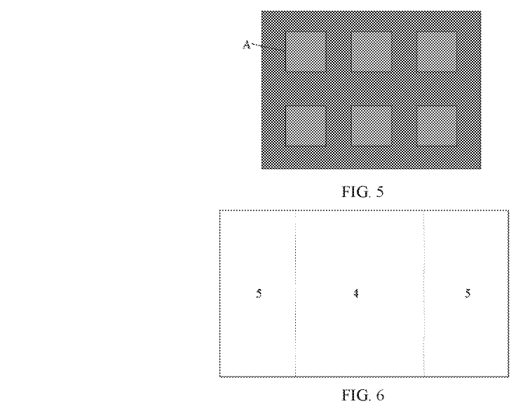

FIG. 5 is a 3D image at a first view point according to an embodiment of the present disclosure. According to an exemplary embodiment illustrated in FIG. 5, the observer can see the main pattern A at the first view point, where the visibility of the main pattern A reflects a crosstalk degree caused by the third visual area V3 and the fourth visual area V4.

After the thickness of the liquid crystal prism 2 has a deviation, a propagation optical path of the light in the liquid crystal may be changed, such that a focal plane of the liquid crystal prism 2 may shift in a thickness direction. This may cause a misalignment between an image source plane and a focal plane of the liquid crystal prism 2 in the thickness direction, and the crosstalk caused by the misalignment may not have regionality. After the position of the liquid crystal prism 2 is laterally shifted, the image source plane and the focal plane of the liquid crystal prism 2 may be laterally misaligned, and the crosstalk caused by this misalignment may have a regional difference. Moreover, the crosstalk caused by the two factors may have weak correlation in the generation factors. By separately improving the crosstalk according to the two generation factors, there may be no mutual interference between two adjustments.

In this regard, embodiments of the present disclosure provide the above method for calibrating the liquid crystal prism, which may simultaneously eliminate two types of crosstalk caused by thickness fluctuation and lateral shift of the liquid crystal prism 2. Put another way, the method may reduce the crosstalk caused by two factors by using one calibration process, thus improving the calibration efficiency.

Specifically, step S1 and step S2 are processes of calibrating the driving voltage of the liquid crystal prism 2. After the driving voltage of the liquid crystal prism 2 is calibrated, crosstalk caused by thickness fluctuation of the liquid crystal prism 2 can be eliminated. Step S3 is a process of calibrating the corresponding relationship between the plurality of sub-pixels 3 overlapped by the liquid crystal prism 2 and the plurality of visual areas V. After the corresponding relationship between the sub-pixels 3 and the visual areas V is calibrated, crosstalk caused by lateral shift of the liquid crystal prism 2 can be eliminated.

In step S1, considering that the crosstalk caused by the thickness fluctuation of the liquid crystal prism 2 does not have regionality, the third visual area V3 and the fourth visual area V4 may both be controlled to display the second image P2.I In this process, the crosstalk reflected by the visibility of the main pattern A at the first view point may include the crosstalk caused by a thickness factor. Further, in step S2, the driving voltage of the liquid crystal prism 2 may be adjusted according to the visibility of the main pattern A at the first view point. The adjustment of the driving voltage of the liquid crystal prism 2 can change the effective refractive index of the liquid crystal in the liquid crystal prism 2, such that an equivalent optical path is changed. The change of the equivalent optical path may counteract an optical path change caused by the thickness fluctuation, and the misalignment influence of the thickness fluctuation on the image source plane and the focal plane may be eliminated. The second driving voltage acquired in step S2 may be a better driving voltage after calibration. When the second driving voltage is used for driving at the current thickness of the liquid crystal prism, the crosstalk influence caused by the thickness factor can be eliminated.

In step S3, in the process of displaying the first image P1 in the first visual area V1 and second visual area V2, and displaying the second image P2 in the third visual area V3 and the fourth visual area V4, the driving voltage of the liquid crystal prism 2 may be adjusted to the second driving voltage, thereby eliminating the crosstalk caused by the thickness factor. On this basis, because the crosstalk caused by the lateral shift of the liquid crystal prism 2 has regionality, one of the third visual area V3 and the fourth visual area V4 may be controlled to display the second image P2, and the other may be controlled not to display in the same period. By displaying an interference image in a single-side non-effective visual area, the crosstalk caused by the lateral shift of the liquid crystal prism 2 can be detected. Further, the corresponding relationship between the plurality of sub-pixels 3 overlapped by the liquid crystal prism 2 and the plurality of visual areas V may be adjusted according to the visibility of the main pattern A at the first view point. The second mapping relationship acquired in step S3 may be a calibrated corresponding relationship, and the corresponding relationship may match the current lateral shift of the liquid crystal prism 2. Under the current alignment condition of the liquid crystal prism 2 and the display panel 1, and when the liquid crystal prism 2 is derived under the second mapping relationship, the crosstalk influence caused by the lateral shift factor can be eliminated.

Additionally, in embodiments of the present disclosure, the first image P1 displayed in the effective visual area at the first view point may be designed as a solid-color image that does not include a pattern, and interference caused by a pattern existing in the first image P1 on determination of the visibility of the main pattern A can be prevented, the accuracy of crosstalk determination is improved.

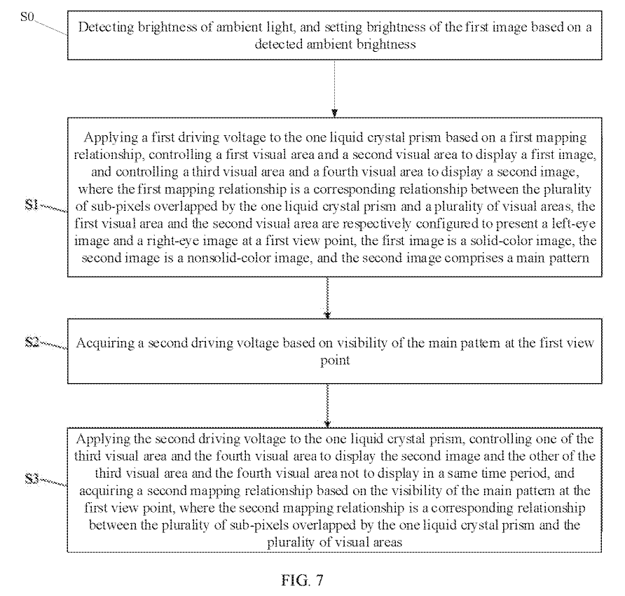

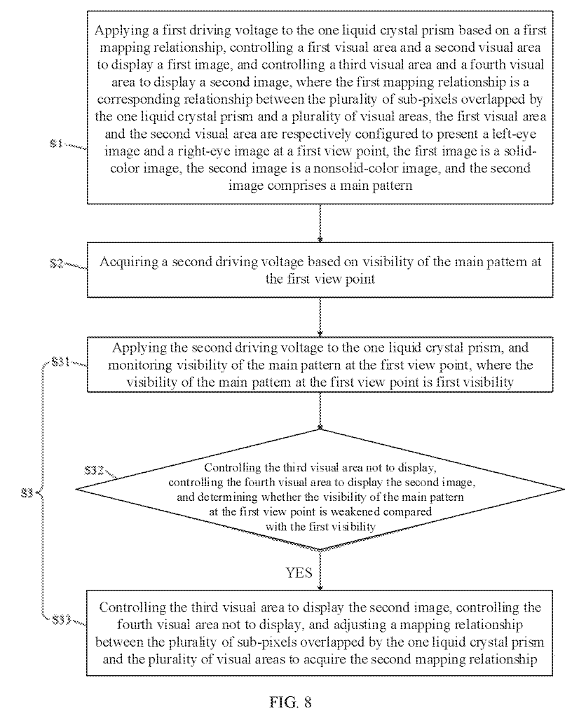

FIG. 6 is a schematic diagram of region division of a display device according to an embodiment of the present disclosure. According to an exemplary embodiment illustrated in FIG. 6, the display device includes a middle display area 4. Further, the display device further includes edge display areas 5 located on two opposite sides of the middle display area 4.

The first view point is positioned facing the middle display area 4. The view point directly facing the middle of the screen may be a main view point, and the effect of the 3D image perceived by the observer at this view point is more important. Therefore, the first view point may be set to be a view point directly facing the middle display area 4, so that the driving voltage of the liquid crystal prism 2 and the corresponding relationship between the plurality of sub-pixels 3 overlapped by the liquid crystal prism 2 and the plurality of visual areas V are calibrated based on the crosstalk condition at this view point, resulting in a higher quality 3D image presentation effect after calibration.

Referring again to FIG. 2, the third visual area V3 is adjacent to the first visual area V1, and the fourth visual area V4 is adjacent to the second visual area V2. Further, the third visual area V3 is located on a side of the first visual area V1 away from the second visual area V2, and the fourth visual area V4 is located on a side of the second visual area V2 away from the first visual area V1.

Crosstalk caused by the non-effective visual area adjacent to the effective visual area may have a more serious influence on a 3D effect. Therefore, two visual areas V adjacent to the two effective visual areas V1 and V2 may be set to be the third visual area V3 and the fourth visual area V4, such that the driving voltage of the liquid crystal prism 2 and the corresponding relationship between the plurality of sub-pixels 3 overlapped by the liquid crystal prism 2 and the plurality of visual areas V may be calibrated based on the crosstalk condition of the two non-effective visual areas, resulting in a superior presentation effect of the calibrated 3D image.

Referring again to FIG. 2, the first image P1 may be a dark-state image, and the main pattern A may be a bright-state pattern. For example, the exemplary main pattern A in FIG. 2 is a white pattern. For example, if both the first image P1 and the main pattern A are both in the bright state or in the dark state, at the first view point, the change of the visibility of the main pattern A may be difficult to identify due to the close brightness of the main pattern A and the first image P1, such that the crosstalk degree cannot be determined. By designing the first image P1 to be in the dark state and the main pattern A to be in the bright state, the main pattern A and the first image P1 can have a large brightness difference, and at the first view point, the visibility of the main pattern A can accurately reflect the crosstalk degree.

In step S1, the process of controlling the first visual area V1 and the second visual area V2 to display the first image P1 may include controlling grayscale values of sub-pixels 3 corresponding to the first visual area V1 and the second visual area V2 in the first mapping relationship to be less than or equal to 30. At this time, the brightness of these sub-pixels 3 may be relatively small, and a darker first image P1 may be presented in the first visual area V1 and the second visual area V2, such that the brightness difference between the first image P1 and the main pattern A is increased.

In step S1, the process of controlling the third visual area V3 and the fourth visual area V4 to display the second image P2 may include controlling grayscale values of sub-pixels 3 corresponding to the third visual area V3 and the fourth visual area V4 and used for displaying the main pattern A in the first mapping relationship to be the maximum grayscale values. At this time, the brightness of these sub-pixels 3 may be relatively large, and a brighter main pattern A may be presented in the third visual area V3 and the fourth visual area V4, such that the brightness difference between the main pattern A and the first image P1 is increased.

The maximum grayscale value may be the maximum grayscale in a grayscale range. For example, when the grayscale range is 0 to 255, the maximum grayscale value is 255.

Further, the display panel 1 may have a plurality of brightness levels, and corresponding relationships between grayscale values and brightness values under different brightness levels may be different. That is, in different brightness levels, brightness values corresponding to the same grayscale value may be different.

The plurality of brightness levels may include a preset brightness level. When controlling the first visual area V1 and the second visual area V2 to display the first image P1, the grayscale values of the sub-pixels 3 corresponding to the first visual area V1 and the second visual area V2 in the first mapping relationship may be controlled to be less than or equal to 30 based on the preset brightness level. That is, the brightness of these sub-pixels may be controlled to correspond to the preset brightness level.

When controlling the third visual area V3 and the fourth visual area V4 to display the second image P2, the grayscale values of the sub-pixels 3 corresponding to the third visual area V3 and the fourth visual area V4 and used for displaying the main pattern A in the first mapping relationship may be controlled to be the maximum grayscale value. That is, the brightness of these sub-pixels may be controlled to be the maximum grayscale brightness in the preset brightness level.

For example, the display panel 1 may have a plurality of brightness levels such as 50 nit, 150 nit, 300 nit, 400 nit, 600 nit, and 800 nit, and each brightness level may correspond to grayscale values ranges from 0 to 255.

The preset brightness level may be set as the minimum brightness level. For example, the preset brightness level is set to be 50 nit, such that the first image P1 is darker, and the brightness difference between the first image P1 and the main pattern A may be greater.

Alternatively, when controlling the third visual area V3 and the fourth visual area V4 to display the second image P2, the grayscale values of the sub-pixels 3 corresponding to the third visual area V3 and the fourth visual area V4 and used for displaying the main pattern A in the first mapping relationship may also be controlled to be the maximum grayscale value based on the maximum brightness level. That is, the brightness of these sub-pixels may be controlled to be the maximum grayscale brightness in the greatest brightness level.

For example, the maximum brightness level may be 800 nit, and the brightness of these sub-pixels may be the maximum grayscale brightness in the 800 nit brightness level. In this way, the brightness of these sub-pixels 3 can be maximized, such that the brightness of the main pattern A can be maximized, and the brightness difference between the main pattern A and the first image P1 can be increased.

Referring again to FIG. 2, the second image P2 further may include a solid-color background B, and the solid-color background B may be a dark background. In this embodiment, both the solid-color background B in the second image P2 and the first image P1 are in the dark state, and when the third visual area V3 and/or the fourth visual area V4 displays the second image P2, at the first view point, the brightness difference between the area where the main pattern A is located and other areas is large, so that the visibility of the main pattern A can be accurately determined, and then the crosstalk condition of the third visual area V3 and/or the fourth visual area V4 can be accurately determined.

In order to further reduce the interference of the solid-color background B on the determination of the visibility of the main pattern A, the solid-color background B may be set to be the same as the first image P1 in color and brightness.

FIG. 7 is another flowchart of a method for calibrating a liquid crystal prism of a display device according to an embodiment of the present disclosure. According to an exemplary embodiment illustrated in FIG. 7, before step S1, the method for calibrating the liquid crystal prism of the display device further includes step S0.

Step S0: detecting brightness of ambient light, and setting the brightness of the first image P1 according to a detected ambient brightness.

When the first image P1 is a dark-state image, a brightness base of the first image P1 may be relatively low, and the reflected ambient light may affect the visual effect of the first image P1. Therefore, before controlling the first visual area V1 and the second visual area V2 to display the first image P1, the brightness of external ambient light can be detected, and then the brightness of the first image P1 may be adaptively adjusted according to the ambient brightness, such that the first image P1 can present a better visual effect in the current environment, which can avoid the influence on the subsequent determination of the visibility of the main pattern A.

Further, in step S0, the process of setting the brightness of the first image P1 according to a detected ambient brightness may include searching a plurality of preset ambient brightness intervals for a preset ambient brightness interval matching the detected ambient brightness, and setting an image brightness corresponding to the found preset ambient brightness interval as the brightness of the first image P1 according to a mapping relationship between the preset ambient brightness intervals and the image brightness.

In the mapping relationship between the preset ambient brightness intervals and the image brightness, the preset ambient brightness intervals and the image brightness may be positively correlated. The preset ambient brightness intervals may be positively correlated with the brightness of the first image P1, which means that when it is detected that the external environment is relatively bright, the brightness of the first image P1 may be set to be slightly larger, thereby preventing the first image P1 from being too dark and difficult to see clearly in the too bright external environment. When it is detected that the external environment is relatively dark, the external environment does not affect the visual effect of the first image P1, so the brightness of the first image P1 can be set to be smaller, to ensure that there is a sufficient brightness difference between the first image P1 and the main pattern A.

Step S2 may specifically include applying a plurality of preset driving voltages to the liquid crystal prism 2 in sequence, comparing the visibility of the main pattern A at the first view point after each of the plurality of the preset driving voltage is applied, and setting a preset driving voltage corresponding to minimum visibility as the second driving voltage.

When the driving voltage of the liquid crystal prism 2 is calibrated, some corresponding driving voltages under different focal lengths may be preset first.The liquid crystal prism may be driven by using the preset driving voltages respectively. Each time the liquid crystal prism is driven by a preset driving voltage, the visibility of the main pattern A at the first view point under the preset driving voltage may be determined and recorded. Further, by comparing the recorded plurality of visibility data, the preset driving voltage with the minimum visibility of the main pattern A may be set as the second driving voltage to complete calibration of the driving voltage of the liquid crystal prism 2.

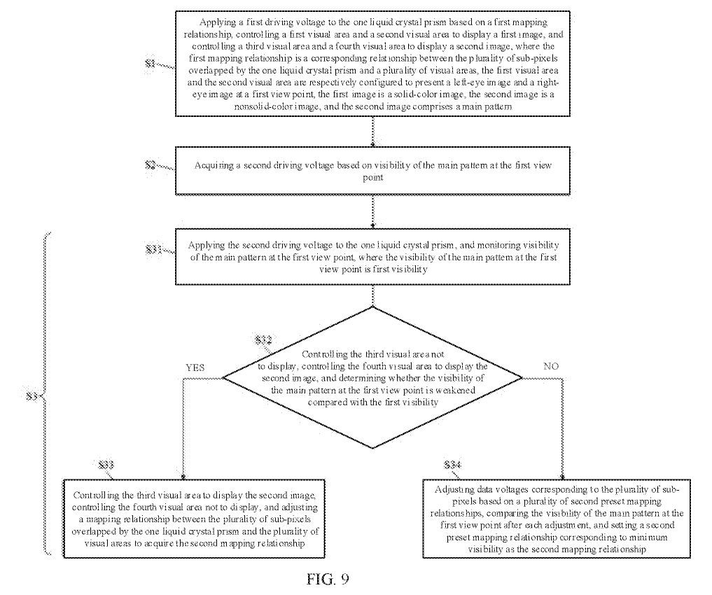

FIG. 8 is another flowchart of a method for calibrating a liquid crystal prism of a display device according to an embodiment of the present disclosure. According to an exemplary embodiment illustrated in FIG. 8, step S3 may specifically include steps of S31, S32, and S33.

Step S31: applying the second driving voltage to the liquid crystal prism 2, and monitoring the visibility of the main pattern A at the first view point. The visibility of the main pattern A at the first view point may be first visibility.

Step S32: controlling the third visual area V3 not to display, controlling the fourth visual area V4 to display the second image P2, and determining whether the visibility of the main pattern A at the first view point is weakened compared with the first visibility, and if yes, step S33 is performed.

Step S33: controlling the third visual area V3 to display the second image P2, controlling the fourth visual area V4 not to display, and adjusting the mapping relationship between the plurality of sub-pixels 3 overlapped by the liquid crystal prism 2 and the plurality of visual areas V to acquire the second mapping relationship.

In step S31, in the process of displaying the first image P1 in the first visual area V1 and second visual area V2, and displaying the second image P2 in the third visual area V3 and the fourth visual area V4, the driving voltage of the liquid crystal prism 2 may be adjusted to the second driving voltage at first, thereby eliminating the crosstalk caused by the thickness factor, such that the crosstalk in the subsequent steps no longer covers the influence of thickness fluctuation. Further, in step S32, the third visual area V3 may be controlled not to display. If it is determined that the visibility of the main pattern A at the first view point in this process is weakened compared with the first visibility in step S31, it may indicate that the crosstalk degree is reduced after the display of the third visual area V3 is turned off. It mayfurther indicate that some crosstalk may be caused by the third visual area V3.

At this time, step S33 may be performed. The display of the third visual area V3 may be turned on, and the display of the fourth visual area V4 may be turned off. In the display process of the third visual area V3, the corresponding relationship between the sub-pixels 3 and the visual areas V may be adjusted to obtain a second mapping relationship matching the current lateral shift condition of the liquid crystal prism 2, so as to complete the calibration of the corresponding relationship between the plurality of sub-pixels 3 overlapped by the liquid crystal prism 2 and the plurality of visual areas V.

In some embodiments, in step S34, the process of adjusting the mapping relationship between the plurality of sub-pixels 3 overlapped by the liquid crystal prism 2 and the plurality of visual areas V to obtain the second mapping relationship includes: adjusting the data voltage corresponding to the sub-pixels 3 according to a plurality of first preset mapping relationships respectively, comparing the visibility of the main pattern A at the first view point after each adjustment, and setting the first preset mapping relationship corresponding to the minimum visibility as the second mapping relationship.

The lateral shift range of the liquid crystal prism 2 may also be limited. Therefore, some corresponding relationships between the sub-pixels 3 and the visual areas V may be preset in advance according to the lateral shift that the liquid crystal prism may have. That is, a plurality of first preset mapping relationships may be set. Further, in the process of turning on the display of the third viewing area V3 and turning off the display of the fourth viewing area V4, the plurality of first preset mapping relationships may be used for testing. Each time the corresponding relationship between the sub-pixels 3 and the visual areas V is adjusted based on the first preset mapping relationship, the visibility of the main pattern A at the first view point under the first preset mapping relationship may be determined and recorded. Further, by comparing the plurality of recorded visibility data, the first preset mapping relationship with the minimum visibility of the main pattern A may be set as the second mapping relationship.

The lateral shift of the liquid crystal prism 2 may include a left shift and a right shift. When the shift directions are different, the adjustment direction of the corresponding relationship between the sub-pixels 3 and the visual areas V may also be different. The first preset mapping relationship may be a preset mapping relationship matching the position of the third visual area V3. For example, when the third visual area V3 is located on the left side of the two effective visual areas of the first visual area V1 and the second visual area V2, and there is the crosstalk in the third visual area V3, it means that the liquid crystal prism 2 is shifted to the right relative to the display panel 1. As such, when the adjustment test is performed based on the first preset mapping relationship, the position of the sub-pixels 3 corresponding to the visual area V may be adjusted to move to the right, so as to match the shift direction of the liquid crystal prism 2.

FIG. 9 is another flowchart of a method for calibrating a liquid crystal prism of a display device according to an embodiment of the present disclosure. According to an exemplary embodiment illustrated in FIG. 9, in step S32, when it is determined that the visibility of the main pattern A at the first view point is not weakened compared with the first visibility, step S34 may be performed.

Step S34: adjusting the data voltages corresponding to the sub-pixels 3 according to a plurality of second preset mapping relationships, comparing the visibility of the main pattern A at the first view point after each adjustment, and setting the second preset mapping relationship corresponding to the minimum visibility as the second mapping relationship.

In step S32, when it is determined that the visibility of the main pattern A at the first view point is not weakened compared with the first visibility, it may indicate that there is no crosstalk in the third visual area V3, and that the current crosstalk can be directly attributed to the fourth visual area V4. In the process of keeping the display of the fourth visual area V4 being turned on, step S34 may be performed. The corresponding relationship between the sub-pixels 3 and the visual areas V may be adjusted to acquire the second mapping relationship matching the current lateral shift condition of the liquid crystal prism 2, so as to complete the calibration of the corresponding relationship between the plurality of sub-pixels 3 overlapped by the liquid crystal prism 2 and the plurality of visual areas V.

The second preset mapping relationship may be the preset mapping relationship matching the position of the fourth visual area V4. For example, when the fourth visual area V4 is located on the right side of the two effective visual areas of the first visual area V1 and the second visual area V2, and there is the crosstalk in the fourth visual area V4, it means that the liquid crystal prism 2 is shifted to the left relative to the display panel 1. As such, when the adjustment test is performed based on the second preset mapping relationship, the position of the sub-pixels 3 corresponding to the visual area V may be adjusted to move to the left to match the shift direction of the liquid crystal prism 2.

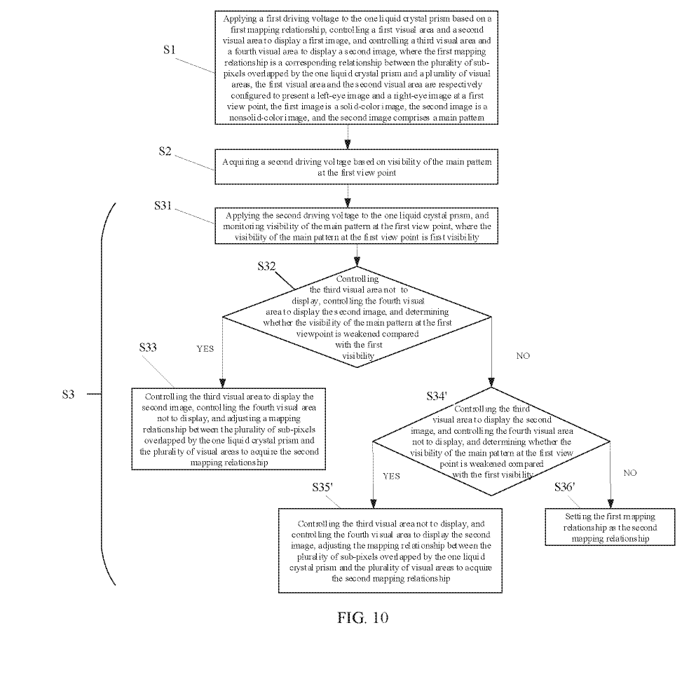

FIG. 10 is another flowchart of a method for calibrating a liquid crystal prism of a display device according to an embodiment of the present disclosure. According to an exemplary embodiment illustrated in FIG. 10, in step S32, when it is determined that the visibility of the main pattern A at the first view point is not weakened compared with the first visibility, step S34’ is performed.

Step S34’: controlling the third visual area V3 to display the second image P2, controlling the fourth visual area V4 not to display, and determining whether the visibility of the main pattern A at the first view point is weakened compared with the first visibility.If yes, step S35’ is performed. If no, step S36’ is performed.

Step S35’: controlling the third visual area V3 not to display, controlling the fourth visual area V4 to display the second image P2, and adjusting the mapping relationship between the plurality of sub-pixels 3 overlapped by the liquid crystal prism 2 and the plurality of visual areas V to acquire the second mapping relationship.

Step S36’: setting the first mapping relationship as the second mapping relationship.

In some embodiments, in step S32, when it is determined that the visibility of the main pattern A at the first view point is not weakened compared with the first visibility, it indicates that there is no crosstalk in the third visual area V3. At this time, step S34’ is performed, the display of the third visual area V3 is turned on, the display of the fourth visual area V4 is turned off, and whether the current crosstalk is caused by the fourth visual area V4 is further determined. If it is determined that it is caused by the fourth visual area V4, the display of the fourth visual area V4 is turned on again, and the corresponding relationship between the sub-pixels 3 and the visual areas V may be adjusted in the process of displaying the second image P2 in the fourth visual area V4 to obtain the second mapping relationship. If it is determined that it is not caused by the fourth visual area V4, it may indicate that the current crosstalk is not caused by the lateral shift of the liquid crystal prism 2, such that the current first mapping relationship may be directly set as the second mapping relationship, and unnecessary adjustment is avoided.

In some embodiments, the process of determining the visibility of the main pattern A at the first view point includes photographing at the first view point, and performing brightness analysis on a photographed image to acquire the visibility of the main pattern A.

This determination method based on brightness analysis and the determination of the crosstalk condition may be more accurate. Specifically, a left eye position and a right eye position at the first view point may be photographed respectively. The brightness analysis may be performed on a visible condition of the main pattern A in the photographed left eye image and right eye image, since the 3D image perceived by the observer at the first view point is synthesized based on the left-eye image and the right-eye image by the brain, the visibility of the main pattern A in the left eye image and the right eye image may reflect the interference degree of the main pattern A in the 3D image perceived by the observer at the first view point, which further reflects the crosstalk condition. Alternatively, the visibility of the main pattern A at the first view point may also be determined by means of human eye observation, which is more direct.

In some embodiments, in step S1, when controlling the first visual area V1 and the second visual area V2 to display the first image P1, and controlling the third visual area V3 and the fourth visual area V4 to display the second image P1, the method for calibrating liquid crystal prism of the display device further includes controlling visual areas V other than the first visual area V1, the second visual area V2, the third visual area V3 and the fourth visual area V4 to display the first image P1.

In some embodiments, each visual area V displays an image. Therefore, each visual area V may also display the image in the calibration process, so that the calibration process is more suitable for practical applications, and the calibrated display effect better meets practical application requirements.

Referring again to FIG. 2, in some embodiments, the main pattern A includes a plurality of square patterns arranged at intervals. The edges of the square pattern may be connected by straight lines, the corners are sharp, and the contour may be free of radian or curve interference, which may result in easier visual resolution and the improved accuracy of determination of the visibility of the main pattern A.

Based on the same inventive concept, embodiments of the present disclosure further provide a display device, which may be any electronic device having a 3D display function.

Referring again to the exemplary embodiment illustrated in FIG. 1, the display device includes the display panel 1 and the plurality of liquid crystal prisms 2 located on the light-emitting side of the display panel 1. The display panel 1 may include the plurality of sub-pixels 3. In the direction perpendicular to a plane where the display panel 1 is located, each liquid crystal prism 2 may overlap a plurality of sub-pixels 3. In some embodiments, the plurality of sub-pixels 3 overlapped by the liquid crystal prism 2 are respectively configured to present images of different viewing areas V. The liquid crystal prism 2 may be calibrated by using the method for calibrating the liquid crystal prism described above.

As described above, after the liquid crystal prism 2 may be calibrated by using the method for calibrating the liquid crystal prism, two types of crosstalk caused by thickness fluctuation and lateral shift of the liquid crystal prism 2 can be eliminated at the same time, and the 3D display effect of the display device is better.

The above description merely illustrates some preferred embodiments of the present disclosure and is not intended to limit the present disclosure, and any modification, equivalent substitution, improvement and the like made within a spirit and a principle of the present disclosure shall fall with the scope of the present disclosure.

Finally, it should be understood that the above embodiments are merely used to illustrate the technical solutions of the present disclosure, but not to limit the same. Although the present disclosure has been described in detail with reference to the above embodiments, those skilled in the art should understand that the technical solutions described in the above embodiments of the present disclosure may still be modified, or some or all of the technical features may be equivalently replaced. These modifications or substitutions do not make the essence of the corresponding technical solutions depart from the scope of the technical solutions in the embodiments of the present disclosure.

What is claimed is:

1. A method for calibrating a liquid crystal prism of a display device, the display device comprising a display panel and a plurality of liquid crystal prisms located on a light-emitting side of the display panel, the display panel comprising a plurality of sub-pixels, one of the plurality of liquid crystal prisms overlapping with the plurality of sub-pixels in a direction perpendicular to a plane of the display panel, and the plurality of sub-pixels overlapped by the one liquid crystal prism being respectively configured to present images of different visual areas,
wherein the method comprises:
applying a first driving voltage to the one liquid crystal prism based on a first mapping relationship, controlling a first visual area and a second visual area to display a first image, and controlling a third visual area and a fourth visual area to display a second image, wherein the first mapping relationship is a first corresponding relationship between the plurality of sub-pixels overlapped by the one liquid crystal prism and a plurality of visual areas, the first visual area and the second visual area are respectively configured to present a left-eye image and a right-eye image at a first view point, the first image is a solid-color image, the second image is a nonsolid-color image, and the second image comprises a main pattern;
acquiring a second driving voltage based on visibility of the main pattern at the first view point; and
applying the second driving voltage to the one liquid crystal prism, controlling one of the third visual area and the fourth visual area to display the second image and the other of the third visual area and the fourth visual area not to display in a same time period, and acquiring a second mapping relationship based on the visibility of the main pattern at the first view point, wherein the second mapping relationship is a second corresponding relationship between the plurality of sub-pixels overlapped by the one liquid crystal prism and the plurality of visual areas.

2. The method according to claim 1, wherein the display device comprises a middle display area, and the first view point is positioned facing the middle display area.

3. The method according to claim 1, wherein the third visual area is adjacent to the first visual area, and the fourth visual area is adjacent to the second visual area.

4. The method according to claim 1, wherein the first image is a dark-state image, and the main pattern is a bright-state pattern.

5. The method according to claim 4, wherein controlling a first visual area and a second visual area to display a first image comprises:
Controlling a first plurality of grayscale values of sub-pixels, corresponding to the first visual area and the second visual area in the first mapping relationship to be less than or equal to 30.

6. The method according to claim 4, wherein controlling a third visual area and a fourth visual area to display a second image comprises:
controlling a second plurality of grayscale values of sub-pixels, corresponding to the third visual area and the fourth visual area in the first mapping relationship and configured for displaying the main pattern to be maximum grayscale values.

7. The method according to claim 4, wherein the second image further comprises a solid-color background, and the solid-color background is a dark-state background.

8. The method according to claim 7, wherein the solid-color background and the first image have the same color and brightness.

9. The method according to claim 1, wherein before controlling the first visual area and the second visual area to display the first image, the method further comprises:
detecting brightness of ambient light; and
setting brightness of the first image based on a detected ambient brightness.

10. The method according to claim 9, wherein setting brightness of the first image based on a detected ambient brightness comprises:
searching a plurality of preset ambient brightness intervals for a preset ambient brightness interval matching the detected ambient brightness, and setting an image brightness corresponding to the found preset ambient brightness interval as the brightness of the first image based on a mapping relationship between preset ambient brightness intervals and image brightness,
wherein in the mapping relationship between the preset ambient brightness intervals and the image brightness, the preset ambient brightness intervals and the image brightness are positively correlated.

11. The method according to claim 1, wherein acquiring a second driving voltage based on visibility of the main pattern at the first view point comprises:
applying a plurality of preset driving voltages to the one liquid crystal prism in sequence, comparing the visibility of the main pattern at the first view point after each of the plurality of preset driving voltages is applied, and setting a preset driving voltage corresponding to minimum visibility as the second driving voltage.

12. The method according to claim 1, wherein applying the second driving voltage to the one liquid crystal prism, controlling one of the third visual area and the fourth visual area to display the second image and the other of the third visual area and the fourth visual area not to display in a same time period, and acquiring a second mapping relationship based on the visibility of the main pattern at the first view point comprises:
applying the second driving voltage to the one liquid crystal prism, and monitoring visibility of the main pattern at the first view point, wherein the visibility of the main pattern at the first view point is first visibility;
controlling the third visual area not to display, controlling the fourth visual area to display the second image, and determining whether the visibility of the main pattern at the first view point is weakened compared with the first visibility; and
when it is determined that the visibility of the main pattern at the first view point is weakened compared with the first visibility, controlling the third visual area to display the second image, controlling the fourth visual area not to display, and adjusting a mapping relationship between the plurality of sub-pixels overlapped by the one liquid crystal prism and the plurality of visual areas to acquire the second mapping relationship.

13. The method according to claim 12, wherein adjusting a mapping relationship between the plurality of sub-pixels overlapped by the one liquid crystal prism and the plurality of visual areas to acquire the second mapping relationship comprises:
adjusting a first plurality of data voltages corresponding to the plurality of sub-pixels based on a plurality of first preset mapping relationships respectively, comparing the visibility of the main pattern at the first view point after each adjustment, and setting a first preset mapping relationship corresponding to minimum visibility as the second mapping relationship.

14. The method according to claim 12, wherein during the process of controlling the third viewing area not to display, and controlling the fourth viewing area to display the second image, the method further comprises:
when it is determined that the visibility of the main pattern at the first view point is not weakened compared with the first visibility, adjusting a second plurality of data voltages corresponding to the plurality of sub-pixels based on a plurality of second preset mapping relationships respectively, comparing the visibility of the main pattern at the first view point after each adjustment, and setting a second preset mapping relationship corresponding to minimum visibility as the second mapping relationship.

15. The method according to claim 12, wherein during the process of controlling the third viewing area not to display, and controlling the fourth viewing area to display the second image, the method further comprises:
when it is determined that the visibility of the main pattern at the first view point is not weakened compared with the first visibility, controlling the third visual area to display the second image, and controlling the fourth visual area not to display, and determining whether the visibility of the main pattern at the first view point is weakened compared with the first visibility,
when it is determined that the visibility of the main pattern at the first view point is weakened compared with the first visibility, controlling the third visual area not to display, and controlling the fourth visual area to display the second image, adjusting the mapping relationship between the plurality of sub-pixels overlapped by the one liquid crystal prism and the plurality of visual areas to acquire the second mapping relationship, or
when it is determined that the visibility of the main pattern at the first view point is not weakened compared with the first visibility, setting the first mapping relationship as the second mapping relationship.

16. The method according to claim 1, further comprising:
photographing at the first view point, and performing brightness analysis on a photographed image to acquire the visibility of the main pattern.

17. The method according to claim 1, wherein during the process of controlling the first visual area and the second visual area to display the first image, and controlling the third visual area and the fourth visual area to display the second image, the method further comprises:
controlling visual areas other than the first visual area, the second visual area, the third visual area and the fourth visual area to display the first image.

18. The method according to claim 1, wherein the main pattern comprises a plurality of square patterns arranged at intervals.

19. A display device, comprising:
a display panel comprising a plurality of sub-pixels; and
a plurality of liquid crystal prisms located on a light-emitting side of the display panel, wherein one of the plurality of liquid crystal prisms overlaps with the plurality of sub-pixels in a direction perpendicular to a plane of the display panel, the plurality of sub-pixels overlapped by the one liquid crystal prism are respectively configured to present images of different visual areas, and
wherein the one liquid crystal prism is calibrated by:
applying a first driving voltage to the one liquid crystal prism based on a first mapping relationship, controlling a first visual area and a second visual area to display a first image, and controlling a third visual area and a fourth visual area to display a second image, wherein the first mapping relationship is a first corresponding relationship between the plurality of sub-pixels overlapped by the one liquid crystal prism and a plurality of visual areas, the first visual area and the second visual area are respectively configured to present a left-eye image and a right-eye image at a first view point, the first image is a solid-color image, the second image is a nonsolid-color image, and the second image comprises a main pattern;
acquiring a second driving voltage based on visibility of the main pattern at the first view point; and
applying the second driving voltage to the one liquid crystal prism, controlling one of the third visual area and the fourth visual area to display the second image and the other of the third visual area and the fourth visual area not to display in a same time period, and acquiring a second mapping relationship based on the visibility of the main pattern at the first view point, wherein the second mapping relationship is a second corresponding relationship between the plurality of sub-pixels overlapped by the one liquid crystal prism and the plurality of visual areas.
